(19) United States
(12) Patent Application Publication
(10) Pub. No.: US 2026/0267265 A1
(43) Pub. Date: Sep. 10, 2026

(54) POWER CONTROL FOR A FUSER OF AN IMAGING DEVICE

(71) Applicant: LEXMARK INTERNATIONAL, INC., LEXINGTON, KY (US)

(72) Inventor: JEFFREY THOMAS HINES, NICHOLASVILLE, KY (US)

(21) Appl. No.: 19/073,991

(22) Filed: Mar. 7, 2025

(51) Int. Cl. G03G 15/00; G03G 15/20; H02M 1/08; H02M 1/14; H02M 1/42

(52) U.S. Cl. CPC G03G 15/5004; G03G 15/2039; H02M 1/083; H02M 1/14; H02M 1/4291; G03G 2215/00978

(57) ABSTRACT

An imaging device includes a fuser having a heater connected to a power source via a switch. A controller generates a heater control signal for driving the heater. The heater control signal changes between a first state indicating for the heater to be turned on and a second state indicating for the heater to be turned off. A latch circuit receives the heater control signal and latches the switch on when the heater control signal is in the first state such that the switch causes current to pass through from the power source to the heater. The latch circuit keeps the switch on until a next zero crossing is detected.

### CROSS REFERENCE TO RELATED APPLICATIONS

This patent application is related to the U.S. patent application Ser. No.______, titled “Power Control for a Fuser of an Imaging Device,” which is filed contemporaneously herewith and assigned to the assignee of the present application.

### STATEMENT REGARDING FEDERALLY SPONSORED RESEARCH OR DEVELOPMENT

None.

### BACKGROUND

### Field of the Invention

The present disclosure relates in general to a power control system, and more particularly to power control methods and systems for controlling the power delivered to a fuser of an imaging device using.

### Description of Related Art

In an electrophotographic (EP) imaging process used in laser printers, copiers and the like, a photosensitive member, such as a photoconductive drum, is uniformly charged over an outer surface. An electrostatic latent image is formed by selectively exposing the uniformly charged surface of the photosensitive member. Toner particles are applied to the electrostatic latent image, and thereafter the toner image is transferred to a media sheet intended to receive the final image. The toner image is fixed to the media sheet by the application of heat and pressure in a fuser assembly. The fuser assembly may include a heated roll and a backup roll forming a fuser nip through which the media sheet passes. Alternatively, the fuser assembly may include a fuser belt, a heater disposed within the belt around which the belt rotates, and an opposing backup member, such as a backup roll.

Imaging devices typically draw power from an electrical power grid, i.e., the AC (alternating current) line power, to operate. During a fusing operation, the fuser assembly draws relatively large amounts of power to heat the fuser that may cause large AC mains disturbances which, in turn, may generate severe harmonics and noticeable flicker. In most geographical locations, strict certification requirements such as flicker, harmonics, current symmetry, radiation, and conduction requirements are set to reduce their undesirable effects on health and/or other sensitive electronic/electrical equipment. The inventors recognize a need for implementing a fuser power control system that can achieve such certification requirements while not compromising temperature control performance.

### SUMMARY OF THE INVENTION

A fuser power control system according to one example embodiment generates heater control signals for a fuser of an imaging device. In one embodiment, the imaging device includes a power source for supplying power to a heater of the fuser. A controller generates a heater control signal for driving the heater to generate heat. The heater control signal changes between a first state indicating for the heater to be turned on and a second state indicating for the heater to be turned off. A converter circuit, such as a Buck Power Factor Correction (PFC) converter, is connected to the power source and is configured to provide an unfiltered, regulated full rectified DC output to be supplied to the heater. In one embodiment, the Buck PFC converter includes a clipper circuit for clipping an output voltage of the DC output for limiting an output current passing through the heater.

A switch, such as a Metal Oxide Semiconductor Field Effect Transistor (MOSFET), is connected between the heater and the Buck PFC converter for selectively allowing current to pass from the Buck PFC converter through the heater. A latch circuit, such as a Set-Reset (SR) latch, is coupled between the controller and the MOSFET. The SR latch is configured to receive the heater control signal from the controller and provide an output that keeps the MOSFET “on” in response to receiving the heater control signal at the first state. The SR latch is configured to latch “off” the MOSFET to turn the heater off at the next zero crossing of the AC voltage of the power source immediately after the MOSFET has been latched “on”. To detect zero crossings, a zero cross (ZC) circuit is employed which provides zero-cross feedback pulses to the SR latch that are used by the SR latch to determine when to latch the MOSFET “off” to turn the heater off. A watchdog timer is connected between the ZC circuit and the SR latch to reset the SR latch if a zero crossing is not detected within a predetermined period which may be slightly longer than the duration of half the line period.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein. Like numerals represent like features in the drawings.

FIG. 1 is a diagrammatic view of an imaging device, including cutaway with a diagrammatic view of a fuser assembly according to an example embodiment.

FIG. 2 illustrates a fuser power control system having a buck power factor correction (PFC) converter according to an example embodiment.

FIG. 3 shows example waveforms illustrating buck PFC voltage and current output waveshapes with current limiting according to an example embodiment.

FIG. 4 is a graph illustrating an example characteristic curve of resistance versus temperature of a positive thermal coefficient (PTC) heater element according to an example embodiment.

FIG. 5 is a graph illustrating an example behavior of power delivery from the buck PFC converter to the PTC heater element according to an example embodiment.

FIG. 6 is a schematic illustrating DC heater control using a MOSFET according to an example embodiment.

FIG. 7 is a block diagram of a power switch control for a fuser according to an example embodiment.

FIG. 8 is a block diagram of a power switch control for a fuser using a microcontroller according to another example embodiment.

FIG. 9 is a timing diagram illustrating example signals of the fuser power control system during normal operation according to an example embodiment.

FIG. 10 is a timing diagram illustrating example signals of the fuser power control system with an incident where a zero cross signal is not detected according to an example embodiment.

### DETAILED DESCRIPTION OF THE INVENTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

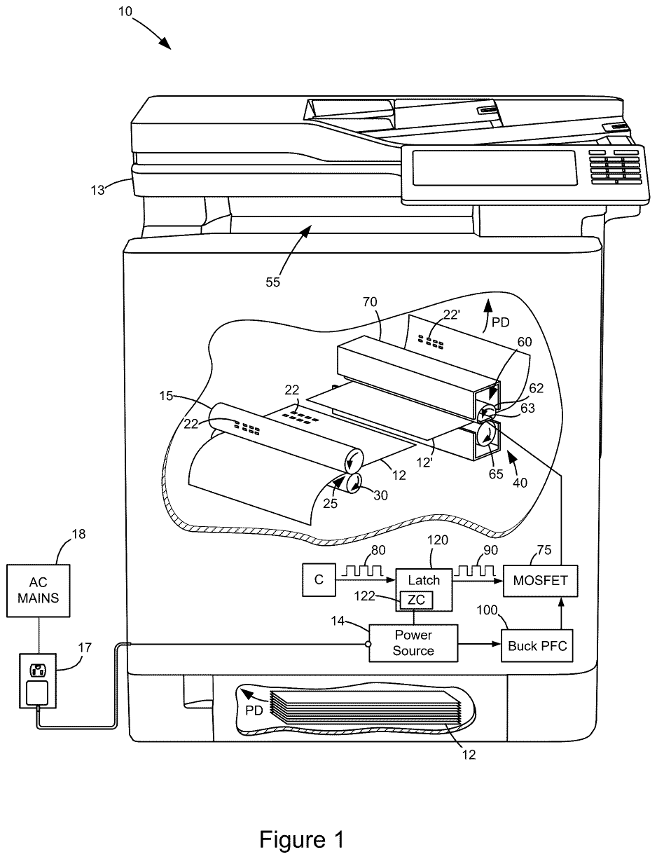

With reference to FIG. 1, an electrophotographic imaging device 10 is shown according to an example embodiment. Imaging device 10 is used for printing images on media 12. Image data of the image to be printed on the media is supplied to imaging device 10 from a variety of sources such as a scanner 13, computer, laptop, mobile device, or like computing device. The sources directly or indirectly communicate with imaging device 10 via wired and/or wireless connection. A controller (C), such as an ASIC(s), circuit(s), microprocessor(s), etc., receives the image data and controls hardware of imaging device 10 to convert the image data to printed data on the sheets of media 12. A power source 14, which may include a low voltage power supply and/or a high voltage power supply, provides power to many of the components and modules of imaging device 10. In this example, imaging device 10 includes a cable connected to power source 14 and ending in a plug that plugs into an AC line or wall outlet 17 connected to the AC mains 18.

During use, controller (C) controls one or more laser or light sources (not shown) to selectively discharge areas of a photoconductive (PC) drum 15 to create a latent image of the image data thereon. Toner particles are applied to the latent image to create a toned image 22 on PC drum 15. At a transfer nip 25 formed between PC drum 15 and a transfer roll 30, the toned image 22 from PC drum 15 is transferred to a media sheet 12 travelling in a process direction PD. Media sheet 12′ with toned image 22 enters a fuser 40 to be applied with heat and pressure to fuse toned image 22 to media sheet 12'. Media sheet 12′ with fused toner image 22′ exits fuser 40 and is either deposited into an output media area 55 or enters a duplex media path for transport to PC drum 15 for imaging on the other side of the media sheet 12′.

In the example shown, fuser 40 has a heat transfer member 60 and a backup roll 65 disposed within a housing 70. Heat transfer member 60 and backup roll 65 forms a fusing nip therebetween. Heat transfer member 60 includes an endless fuser belt 62 and a heater 63 that contacts an inner surface of fuser belt 62 so that heat generated by heater 63 heats fuser belt 62 to a temperature sufficient to perform a fusing operation on sheets of media at the fusing nip. Heater 63 may be formed from a substrate of ceramic or like material to which at least one resistive trace is secured which generates heat when a current is passed through it. For example, heater 63 may include a positive thermal coefficient (PTC) heater element and/or an aluminum nitride (AlN) heater element. Backup roll 65 contacts fuser belt 62 such that fuser belt 62 rotates in response to backup roll 65 rotating, as indicated by their direction arrows, to convey media through the fusing nip in process direction PD.

In one example embodiment, power is applied to heater 63 for fusing sheets of media using DC power. In the example embodiment illustrated, a buck Power Factor Correction (PFC) converter 100 connected between power source 14 and heater 63 is used for heating heater 63. In this example, buck PFC converter 100 provides both power factor correction and DC-DC voltage conversion. In particular, buck PFC converter 100 is configured to accept a universal AC input range from power source 14 and provide a DC output that is compatible with heater 63. For example, buck PFC converter 100 may provide an output voltage that is at or lower than a lowest operational voltage of heater 63.

In the example embodiment illustrated, a Metal Oxide Semiconductor Field Effect Transistor (MOSFET) circuitry 75 connected between heater 63 and buck PFC converter 100 is used to switch heater 63 on and off based on a heater control signal, shown as heat-on pulses 80, generated by controller (C). In one embodiment, controller (C) generates heat-on pulses 80 without synchronizing the generation of the heat-on pulses with zero-crossings of the AC line voltage such that controller (C) does not require zero-cross feedback as input in order to generate heat-on pulses 80 for controlling MOSFET circuitry 75. Instead, controller (C) works in conjunction with a latch circuit 120 having zero cross (ZC) detection functionality to generate drive pulses 90 for driving MOSFET circuitry 75 and providing DC power to heater 63, as will be discussed in greater detail below. A ZC detector 122 may be implemented in latch circuit 120 or provided separately from latch circuit 120.

Controller (C) generates heat-on pulses 80 based on an amount of power to be delivered to heater 63 to achieve a target and/or desired fusing temperature. If fuser 40 is not at the desired temperature, the power change can be instituted to increase or decrease the DC power delivered to heater 63. If power is to be increased, for example, then controller (C) can correlate the desired increase in DC power to a table to determine pulse waveform patterns of the MOSFET drive signals to achieve such power. In carrying out the changes in the power delivered to heater 63, various algorithms can be employed such as proportional-integral-derivative (PID) algorithms to assure that the rate of change in the power is proper so as to minimize any undershoot or overshoot.

In the example shown, latch circuit 120 receives heat-on pulses 80 from controller (C) as input and provides drive pulses 90 as output to MOSFET circuitry 75. Drive pulses 90 from latch circuit 120 allow the activation of MOSFET circuitry 75 when the heat-on pulse 80 from controller (C) is high in order to turn on heater 63, and keep heater 63 turned on until the next zero crossing of the AC line voltage of the power source 14 is detected by the ZC detector 122, as discussed below.

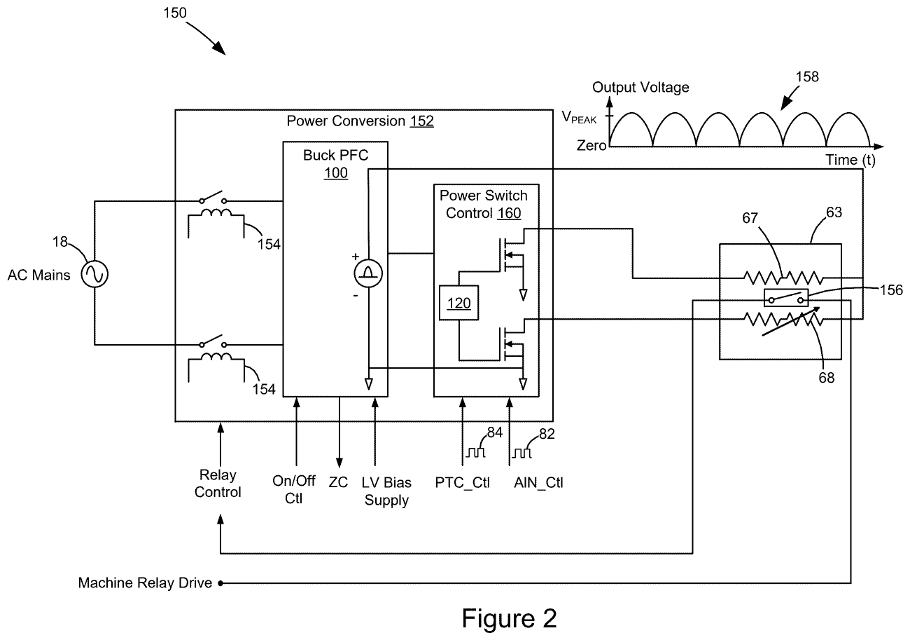

FIG. 2 illustrates an example diagram of a fuser power control system 150 according to one example embodiment. A power conversion function block 152, which may be implemented in controller (C) or provided separately from controller (C), controls power delivered from the AC mains 18 to heater 63 including one or more heater elements, such as a first heater element 67 (AlN) and a second heater element 68 (PTC). Power conversion function block 152 includes buck PFC converter 100. Safety relays 154 are used to provide electrical isolation between the AC mains 18 and buck PFC converter 100. In one example, safety relays 154 may disconnect if a fault occurs that causes overcurrent conditions and/or if in case of overvoltage or undervoltage conditions which may otherwise damage buck PFC converter 100 or other downstream components. In another example, safety relays 154 are connected to a thermal cut-off device 156 that activates when the temperature of heater 63 exceeds a threshold in order to control safety relays 154 to cutoff the power supply and protect heater 63 from overheating and/or prevent potential damage.

Buck PFC converter 100 is configured to accept a range of AC input voltages from the AC mains 18. When safety relays 154 are closed, the AC voltage is rectified by buck PFC converter 100 using a bridge rectifier or similar component to convert the AC voltage into a pulsating rectified DC voltage. After rectification, the PFC circuit of buck PFC converter 100 improves the power factor. For example, the PFC circuit adjusts the input current to be in phase with the input voltage to reduce reactive power and minimize losses in the power supply. After power factor correction by the PFC circuit, buck PFC converter 100 steps down the DC voltage to a lower DC voltage suitable for heater 63, as shown by the pulsating DC output voltage 158. In one embodiment, buck PFC converter 100 provides the pulsating DC output voltage 158 to heater 63 as an unfiltered, regulated full-rectified output voltage to heater 63. For example, at the output of buck PFC converter 100, no filtering and/or smoothing downstream components or circuitry are used to filter and/or smooth out the pulsating DC output voltage 158 into a steady DC output such that the pulsating DC output voltage 158 is directly provided to heater 63.

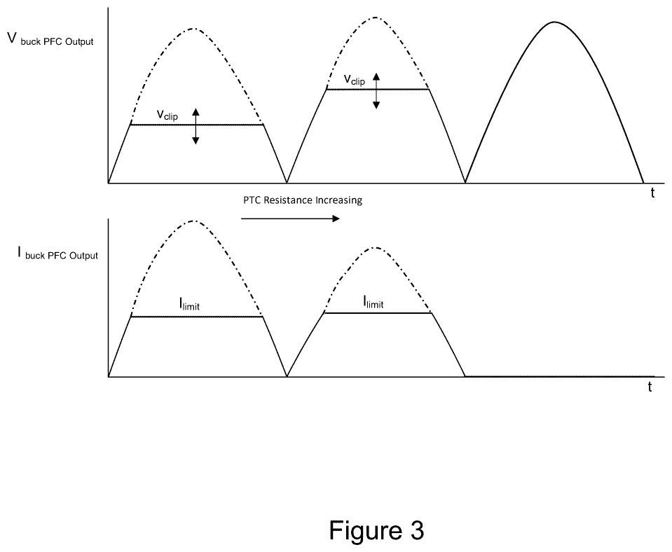

Applying unregulated power in conventional control algorithms may result in transitory peak power into the heater element in excess of an amount that may cause high thermal gradient stresses in the heater element. In one example embodiment, buck PFC converter 100 includes output current limiting features to provide heater 63 with a controlled peak power limit to minimize stress, and to provide a regulated RMS output voltage (e.g., 115v RMS from 230v input range) once heater 63 is in its operating space. Output current limiting may be achieved using techniques known in the art. For example, buck PFC converter 100 may include a clipper circuit for clipping an output voltage of the DC output for limiting an output current passing through heater 63. FIG. 3 shows example waveforms illustrating buck PFC output voltage and current output waveshapes with voltage clipping and current limiting. In the example shown, clipping the buck PFC output voltage regulates and/or limits the buck PFC output current. The clipping voltage may be adjusted to achieve a desired level of current output limiting. In one example, the clipping voltage may be adjusted to maintain substantially the same level of current output limiting as the resistance of the PTC heater element increases with increasing temperature.

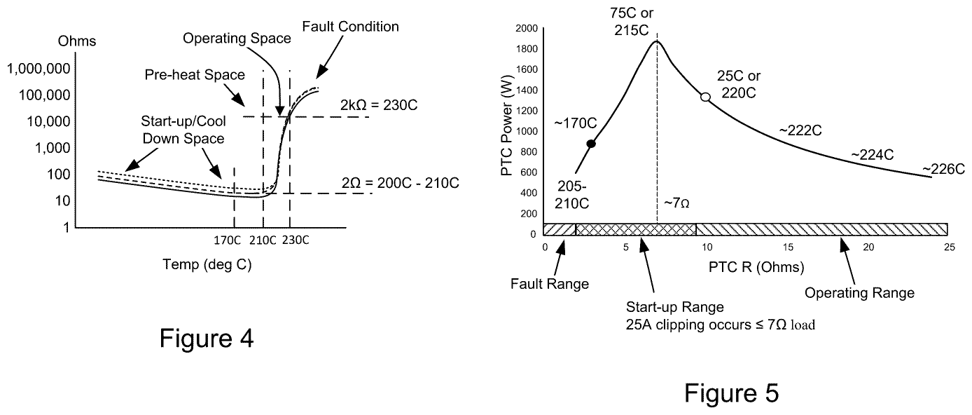

FIGS. 4 and 5 depict an example operational characteristic of the buck PFC converter 100 with current limiting. FIG. 4 is a graph illustrating an example characteristic curve of resistance versus temperature of a PTC heater element while FIG. 5 is a graph illustrating an example behavior of power delivery from buck PFC converter 100 to the PTC heater element. It is noted that FIGS. 4 and 5 show representative models provided for purposes of illustration to facilitate understanding of the present disclosure and thus should not be considered limiting.

In the example shown in FIG. 4, the PTC heater element exhibits distinct resistance versus temperature characteristics across various phases. In this example, resistive values on the vertical axis correspond to one PTC heater element of an example heater having 10 parallel heater elements (i.e., to obtain the resistance of the heater, the resistive values are divided by 10). During the start-up phase, the resistivity of the PTC heater element remains relatively constant or decreases slightly at lower temperatures allowing a high current flow to rapidly increase the temperature. Conversely, in the same space during cooldown when the power is turned off, the temperature decreases and the resistance drops back to its initial low value, preparing for the next startup cycle. In the pre-heat space, the temperature of the PTC heater element rises gradually while the resistance remains relatively low and stable until it approaches a certain threshold temperature known as the Curie point. At the Curie point, the resistance begins to increase sharply, marking the transition to the operating space. In the operating space, the PTC heater element exhibits self-regulating behavior wherein as the temperature exceeds the Curie point, the resistance increases rapidly thereby reducing current flow and limiting further temperature rise, thus preventing overheating and maintaining a stable operating temperature. If the PTC heater element overheats beyond the operating space, a fault condition may occur.

The peak power delivery into the dynamic resistive load of heater 63 may be controlled in a manner such that buck PFC converter 100 simultaneously limits AC mains demand to reasonable values (e.g., values that limit mains flicker, AC mains fuse/breaker fatigue, etc.) while maintaining the needed power delivery to the heater element. Within the start-up range shown in FIG. 5, buck PFC converter 100 drives the heater causing power delivered to the heater to initially increase as current flows through the heater and the heater heats up. When the instantaneous load current reaches 25 A (e.g., when the heater resistance reaches 7 Ω), buck PFC converter 100 switches from a voltage control mode to a current limiting mode causing power delivery to the heater to decrease. Within the operating range, power delivery through the heater stabilizes at a reduced level relative to the power delivered before current limiting. By providing a fixed current limit on the buck PFC supply, high thermal gradient stresses on the PTC heater element(s) can be significantly reduced while providing more consistent heating performance when in its operating space.

Referring back to FIG. 2, power conversion function block 152 includes a power switch control block 160. Power switch control block 160 includes latch circuit 120 that receives heat-on pulses 80 from controller (C) and the MOSFET circuitry 75 that is connected to heater 63. In the example shown, the MOSFET circuitry 75 has outputs that are connected to first heater element 67 and second heater element 68 of heater 63. Each heater element may include one resistive element or multiple resistive elements connected in parallel. Power switch control block 160 receives heat-on pulses 80 from controller (C) including a first heat-on pulse signal 82 for controlling first heater element 67 and a second heat-on pulse signal 84 for controlling second heater element 68.

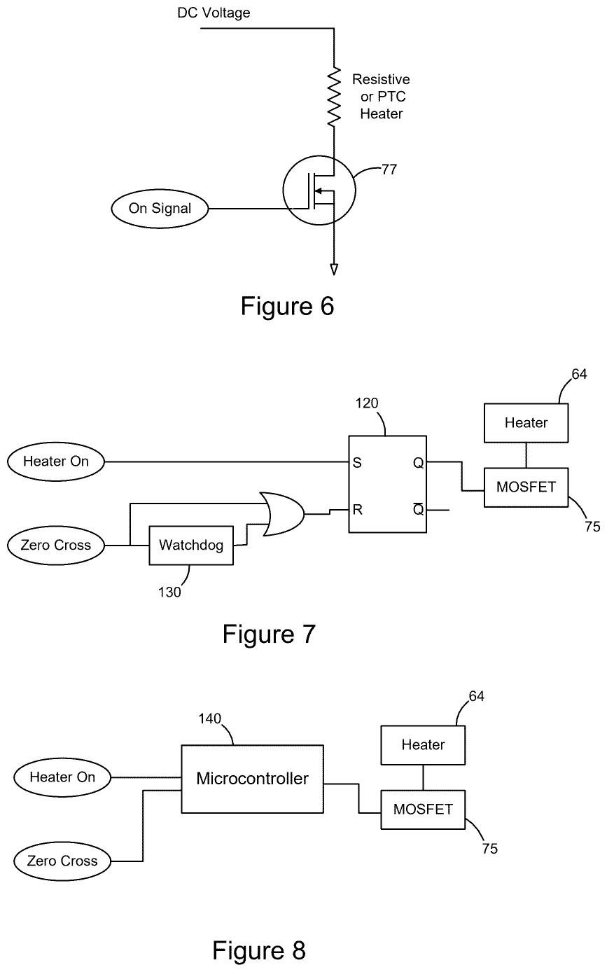

FIG. 6 is a simplified schematic illustrating DC heater control using a MOSFET 77 of MOSFET circuitry 75 according to an example embodiment. MOSFET 77 is a voltage-driven device that operates based on the voltage applied to its gate terminal (shown receiving the “On Signal”), which controls the current flow through the heater element. When the “On Signal” is low, no current flows through the heater element. When the “On Signal” is high, current flows through the heater element causing the heater element to generate heat.

FIG. 7 is a block diagram of power switch control block 160 according to an example embodiment. In the embodiment illustrated, power switch control block 160 includes MOSFET circuitry 75, latch circuit 120 shown as a Set-Reset (SR) latch 120, and a watchdog timer 130. In an alternative embodiment, a microcontroller 140 may be used to achieve the same behavior such as shown in FIG. 8.

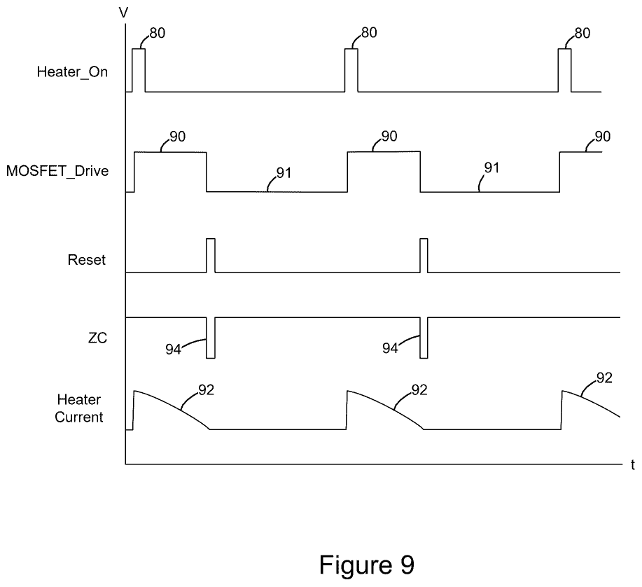

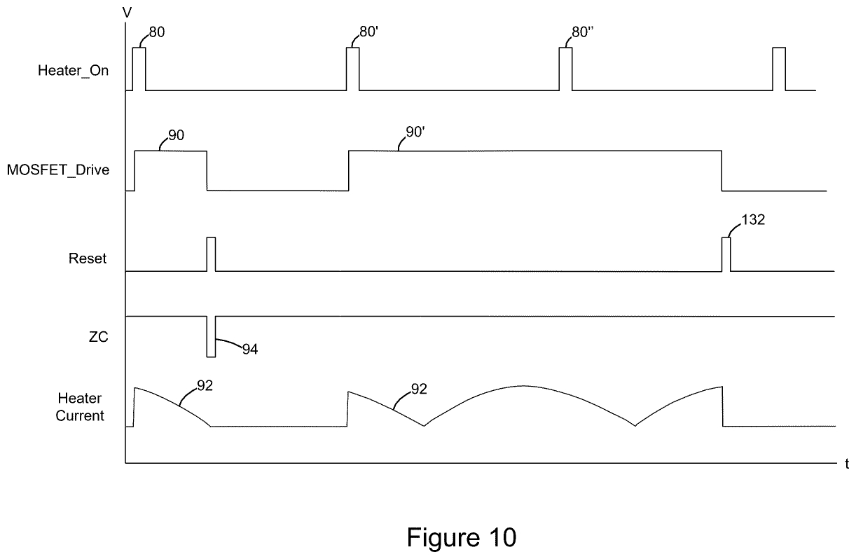

The operation of power switch control block 160 will be described with additional reference to example timing diagrams 170, 180 shown in FIGS. 9 and 10. It is further noted that FIGS. 9 and 10 show representative models provided for purposes of illustration to facilitate understanding of the present disclosure and thus should not be considered limiting. During use, SR latch 120 receives a Heater_On signal at its Set(S) input and provides a MOSFET_Drive signal at its Q output to MOSFET circuitry 75 in response to receiving the Heater_On signal. MOSFET circuitry 75 requires its “On Signal” to be on for the entire duration that MOSFET circuitry 75 is desired to be on. In order to keep MOSFET circuitry 75 on when a heat-on pulse 80 of the Heater_On signal is sent to power switch control block 160, SR latch 120 latches MOSFET circuitry 75 on by providing a drive pulse 90 of the MOSFET_Drive signal to allow current 92 to flow through the heater element, thus causing heater 63 to turn on. Thereafter, MOSFET circuitry 75 needs to be latched ‘off’ at the next zero crossing of the AC line voltage. In this example, a ZC signal from a zero-cross detect circuit (not shown) is connected to the reset (R) input of the SR latch 120. When a ZC pulse 94 of the ZC signal occurs (shown following after the Heater_On signal transitions from a high state corresponding to heat-on pulse 80 to a low state and before the next heat-on pulse 80 occurs), the reset (R) input of SR latch 120 is set to 1 which then sets its Q output to 0 causing the MOSFET_Drive signal to transition to a low state 91. In turn, heater 63 is turned off as current stops flowing through the heater element. The ZC signal can be derived from the AC mains even though the voltage being applied to the heater control circuit is DC which may or may not have a zero-voltage crossing point (e.g. full-wave rectified sinewave). This approach produces the same time-based power control period as would be used in AC only powered heater circuitry.

Situations may exist where a zero cross pulse may fail to occur. This may include ‘dirty’ power as well as hardware failures like connection problems. If a problem arises in the detection and/or creation of a zero cross pulse, MOSFET circuitry 75 will stay latched ‘on’ allowing current to continue to flow through the heater element. To prevent this, watchdog timer 130 is used to reset SR latch 120 if a zero cross is not detected. For example, watchdog timer 130 may be set with a period slightly longer than the duration of half the normal AC line period. In this manner, power switch control block 160 may safely disconnect the heater(s) when a zero cross signal fails to appear.

Timing diagram 180 in FIG. 10 shows an incident where a ZC pulse fails to occur. As discussed above, SR latch 120 latches MOSFET circuitry 75 on by providing a drive pulse 90 on the MOSFET_Drive signal when a heat-on pulse 80 of the Heater_On signal is received at the Set(S) input of SR latch 120 allowing current 92 to flow through the heater element, thus causing heater 63 to turn on. After a subsequent heat-on pulse 80′, a zero cross pulse fails to occur which, in turn, causes the MOSFET_Drive signal to remain in a high state 90′ as SR latch 120 fails to reset thereby allowing current 92 to continue to flow through the heater element. In this embodiment, watchdog timer 130 is used to provide a reset signal, such as a signal mimicking a ZC pulse, in order to set the Reset (R) input of SR latch 120 to 1 when no ZC pulse occurs. In the example illustrated, watchdog timer 130 provides the reset signal after occurrence of two consecutive heat-on pulses 80′, 80″ causing a reset pulse 132 at the Reset (R) input of SR latch 120. In turn, the Q output of SR latch 120 is set to 0 causing the MOSFET_Drive signal to transition to a low state 91 thereby turning off heater 63 as current stops flowing through the heater element.

With the above example embodiments, fuser power control system 150 with buck PFC converter 100 may be used since buck PFC converter 100 is capable of accepting a universal AC input range from power source 14 and provide a DC output that is compatible with heater 63,

The above example embodiments have been described in the context of using a buck PFC converter in conjunction with MOSFET circuitry for controlling power delivery to a heater. However, it will be appreciated that the teachings and concepts provided herein may utilize other electronic and/or semiconductor devices used in power control and switching applications. Further, although the example embodiments have been described using a fuser power control system, it will be appreciated that the teachings and concepts provided herein may be used in applications that utilize controlled and regulated voltage for other heating devices, such as those involving highly variable load impedances similar to the PTC heater described above.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

We claim:

1. A method for controlling power delivered to a fuser in an imaging device, the fuser having a heater connected to a power source, the method comprising:
receiving a heater control signal for driving the heater to generate heat, the heater control signal changing between a first state indicating for the heater to be turned on and a second state indicating for the heater to be turned off; and
applying a pulsating DC output voltage across the heater to allow current from the power source to flow through the heater and turn on the heater when the heater control signal is in the first state.

2. The method of claim 1, wherein the applying the pulsating DC output voltage across the heater includes applying a full-rectified sinusoidal DC output voltage across the heater.

3. The method of claim 1, wherein the applying the pulsating DC output voltage across the heater includes applying the pulsating DC output voltage using a buck power factor correction (PFC) converter of the power source.

4. The method of claim 1, further comprising clipping the pulsating DC output voltage to regulate the current flowing through the heater.

5. The method of claim 1, wherein the applying the pulsating DC output voltage across the heater includes applying the pulsating DC output voltage without filtering the pulsating DC output voltage using filtering circuitry connected between the power source and the heater.

6. The method of claim 1, wherein the applying the pulsating DC output voltage across the heater includes applying the pulsating DC output voltage without smoothing out the pulsating DC output voltage using smoothing circuitry connected between the power source and the heater.

7. A method for controlling power delivered to a fuser in an imaging device, the fuser having a heater connected to a power source, the method comprising:
receiving a heater control signal for driving the heater to generate heat, the heater control signal changing between a first state indicating for the heater to be turned on and a second state indicating for the heater to be turned off; and
applying an output voltage with current limiting across the heater to regulate current flowing through the heater when the heater control signal is in the first state.

8. The method of claim 7, wherein the applying the output voltage with current limiting includes applying a clipped output voltage across the heater.

9. The method of claim 7, further comprising clipping a pulsating DC output voltage of the power source to produce the output voltage with current limiting.

10. The method of claim 7, further comprising clipping a full-rectified sinusoidal DC output voltage of the power source to produce the output voltage with current limiting.

11. The method of claim 7, wherein the applying the output voltage with current limiting includes applying the output voltage with current limiting using a buck power factor correction (PFC) converter of the power source.

12. The method of claim 7, wherein the applying the output voltage includes applying the output voltage without filtering the output voltage using circuitry connected between the power source and the heater.

13. The method of claim 7, wherein the applying the output voltage includes applying the output voltage without smoothing out the output voltage using circuitry connected between the power source and the heater.

14. An imaging device, comprising:
a fuser having a heater for generating heat to fuse toner images onto sheets of media;
a power source having a buck converter for supplying power to the heater; and
a controller operative to generate a heater control signal for driving the heater to generate heat, the heater control signal changing between a first state indicating for the heater to be turned on and a second state indicating for the heater to be turned off, wherein the buck converter is operative to apply a pulsating DC output voltage across the heater to allow current from the power source to flow through the heater and turn on the heater when the heater control signal is in the first state.

15. The imaging device of claim 14, wherein the buck converter includes a buck power factor correction (PFC) converter.

16. The imaging device of claim 14, wherein the pulsating DC output voltage is a full-rectified sinusoidal DC output voltage.

17. The imaging device of claim 14, wherein the buck converter includes current limiting circuitry for regulating the current flowing through the heater.

18. The imaging device of claim 14, wherein the pulsating DC output voltage is clipped to regulate the current flowing through the heater.

19. The imaging device of claim 14, wherein the pulsating DC output voltage is applied across the heater without filtering the pulsating DC output voltage using filtering circuitry connected between the buck converter and the heater.

20. The imaging device of claim 14, wherein the heater includes a positive thermal coefficient (PTC) heater.
